(19) United States
(12) Patent Application Publication
(10) Pub. No.: US 2006/0212913 A1
(43) Pub. Date: Sep. 21, 2006

(54) Remote control system, controllable device, and remote control method

(76) Inventors: Koji Hirose, Osaka (JP); Ryuichi Sakai, Osaka (JP); Takashi Maniwa, Osaka (JP)

Correspondence Address: GREENBLUM & BERNSTEIN, P.L.C., 1950 ROLAND CLARKE PLACE, RESTON, VA, 20191, US

(21) Appl. No.: 10/550,630

(22) PCT Filed: Mar. 26, 2004
(86) PCT No.: PCT/JP04/04302

§ 371 Date: Jan. 7, 2006

(30) Foreign Application Priority Data
Mar. 27, 2003 (JP) 2003-088421

(51) Int. Cl. H04N 5/445; H04N 7/173

(52) U.S. Cl. 725/86; 725/38

(57) ABSTRACT

In a remote control system to control remotely a controlled device through a network from a terminal at a remote place, the controlled device stores a channel table associating broadcast station numbers recognized by a remote control device and allocated to each broadcast station with channel numbers recognized by the controlled device and allocated to each broadcast station. This allows channel numbers to be designated remotely according to an area, even though a relation between broadcast station numbers and channel numbers is different depending on an area. The remote controller can read the channel table of the controlled device and correct the channel table according to user's operation on the terminal.

### TECHNICAL FIELD

The invention relates to a remote control system which can control an in-home device from an external terminal located at a remote place through a network and a control method therefor.

### BACKGROUND ART

As one of conventional techniques that control in-home devices (to be referred to as a “controlled device” hereinafter) through the Internet, a method of timer recording of TV programs in a video recorder which is a device to be controlled, from a terminal device such as a personal computer (PC) or a mobile telephone by using an electronic program guide (EPG) stored in a server which is connected to the network is known (for example, see JP 2001-145140 A).

In the above system, the controlled device manages channel numbers for each broadcast station. The server manages the numbers which are uniquely determined independently of the channel numbers managed by the controlled device are allocated to the broadcast stations as broadcast station numbers. For this reason, the server has a channel table in which the channel numbers managed by the controlled device and the broadcast station numbers managed by the server itself are associated with each other.

In the server, when control data for timer recording is transmitted to the controlled device, a broadcast station number recognized by the server is converted into a channel number recognized by the controlled device with reference to the channel table, and channel numbers designated in the control data to transmit the control data to the controlled device.

Channel numbers of broadcast stations may be different depending on areas. For example, there may be a case that channel “1” is used for a broadcast station A in one area, while the channel “1” is used for a broadcast station B in the other area. The server may be located on a network and be used by users in various areas. With respect to handling of channel information, regional characteristics of the channel numbers must be considered. When channel numbers are changed due to convenience of broadcast stations or the like, channel numbers stored in a controlled device may not match information of the channel table stored in the server. In such a case, timer recording may not be able to be performed correctly.

### DISCLOSURE OF THE INVENTION

The present invention has been made to solve the above problem, and has its object to provide a remote control system which can solve the problem about regional characteristics of channel numbers and enables change of channel number setting on a controlled device through a network.

A controlled device according to the invention is a device which is controlled on the basis of control information generated by a remote control device according to a user operation on a terminal at a remote place and transmitted through a network. The controlled device stores a channel table which associates “broadcast station numbers” used by the remote control device and allocated to each broadcast station with “channel numbers” used by the controlled device and allocated to each broadcast station. The controlled device receives control information including the broadcast station numbers through the network. The controlled device specifies the channel number on the basis of the received broadcast station number with reference to the channel table, and performs an operation based on the control information with the specified channel number.

The channel table may manage a broadcast station number, a channel number, and a frequency of a broadcast station, by associating them with each other.

A remote control system according to the invention includes a controlled device according to the invention, and a remote control device which transmits control information to the controlled device in accordance with an instruction from the terminal. The remote control device includes a communication controller that receives control information including a broadcast station number through the network from the terminal, and a transmitter that transmits the control information including the received broadcast station number to the controlled device.

The remote control device may include a section that reads a channel table from the controlled device to acquire a relationship between broadcast station numbers and channel numbers when a user operation related to a change in channel table on the terminal, and that changes the relationship on the basis of the user operation on the terminal to transmit the relationship to the controlled device. In this case, the controlled device updates the channel table on the basis of the relationship between the broadcasting station numbers and the channel numbers transmitted from the remote control device.

The remote control device may set an initial relationship between the broadcast station numbers and the channel numbers on the basis of area information which represents an installation area of the controlled device and is designated by a user on a terminal. Thereafter, the relationship may be able to be changed according to a user operation on the terminal.

A remote control method according to the invention is a method for a remote control system including a controlled device controlled from a terminal located at a remote place through a network and a remote control device which transmits control information to the controlled device in accordance with an instruction from the terminal. The control method includes storing a channel table that associates broadcast station numbers with channel numbers in the controlled device, the broadcast station numbers being used by the remote control device and allocated to each broadcast station, the channel numbers being used by the controlled device and allocated to each broadcast station, when a user operation related to a change in the channel table is performed on the terminal, reading the channel table from the controlled device by the remote control device to acquire a relationship between the broadcast station number and the channel number, and changing the relationship on the basis of user operation on the terminal to transmit the relationship to the controlled device; and updating the channel table in the controlled device on the basis of the relationship between the broadcast station number and the channel number transmitted from the remote control device.

Another remote control device according to the invention is a remote control device which receives a control instruction from a terminal through a network, generates control information for a controlled device on the basis of the control instruction to transmit the control information. The remote control device includes a storage section which stores channel tables set for areas respectively. The channel table associates broadcast station numbers recognized by the remote control device and allocated to each broadcast station with channel numbers recognized by the controlled device and allocated to each broadcast station. The remote control device includes a manager that manages area information for specifying an area where the controlled device is used, and a section that selects one table from the tables stored in the storage section on the basis of the area information managed by the manager, specifies a channel number on the basis of the selected table, and transmits the channel number as control information to the controlled device.

According to the present invention, in a remote control device which performs timer recording of a TV program or the like through a network, table data representing a relationship between channel numbers and broadcast station numbers is stored in a controlled device. This allows the controlled device to recognize a correct relationship between channel numbers and broadcast station numbers. Thus, regardless of an area in which the controlled device is disposed, remote control such as timer recording can be performed from anywhere through the network. A user can arbitrarily change or modify a channel table from a remote place through the network and can always recognize a correct relationship between channel numbers and broadcast station numbers in the controlled device. Hence, a timer recording operation can be prevented from being erroneously performed.

### BRIEF DESCRIPTION OF THE DRAWINGS

FIG. 1 is a diagram showing a configuration of a remote control system according to a first embodiment of the present invention.

FIG. 2 is a diagram showing an example of a channel table stored in a channel table storage section of a server in the remote control system.

FIG. 3 is a diagram showing a configuration of a remote control system according to a second embodiment of the present invention.

FIG. 4 is a diagram showing an example of a channel table stored in a channel table storage section of a device in the remote control system.

FIG. 5 is a diagram showing an example of a channel table temporarily stored in a channel table change section of a server in the remote control system.

FIG. 6 is a diagram showing an example display of an operation screen on a remote terminal in a channel setting process of the device from a remote terminal.

### BEST MODE FOR CARRYING OUT THE INVENTION

Embodiments of a remote control system according to the present invention will be described below with reference to the accompanying drawings.

### First Embodiment

(Configuration of Remote Control System)

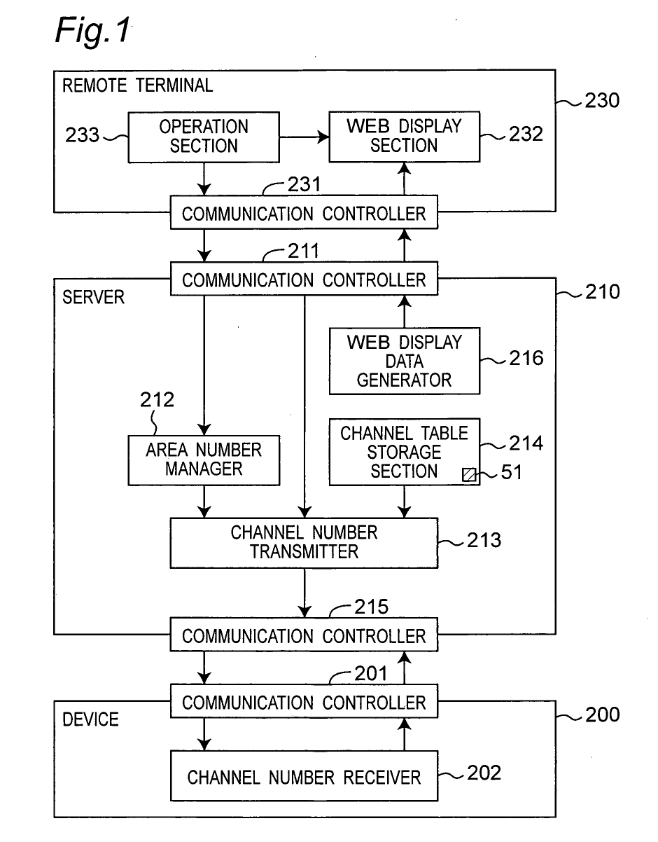

FIG. 1 is a diagram showing the configuration of a remote control system according to the present invention. In FIG. 1, the remote control system includes a device 200 to be controlled, a server 210, and a remote terminal 230. The controlled device 200, the server 210, and the remote terminal 230 are connected to each other through a communication network such as the Internet.

The remote terminal 230 is a remote operation device which can display a WEB (World Wide Web) screen by a browser function and can perform an operation or inputting on the basis of the WEB screen, such as a personal computer (PC) or a mobile telephone. The remote terminal 230 includes a communication controller 231 to communicate through the Internet, a WEB display section 232 to display a WEB screen, and an operation section 233 to perform an operation or inputting on the basis of the WEB screen.

The device 200 is a controlled device which is remote-controlled through the Internet. It is a video recording apparatus such as a DVD recorder which can record a program received from a broadcast station, in the embodiment. The device 200 includes a communication controller 201 which performs communication through the Internet, and a channel number receiver 202 which receives a so-called “channel number” which is a number for specifying a broadcast station.

The server 110 has a function of providing TV program information or the like. The server 210 has a function that generates control information to the device 200 on the basis of an operation commands from the remote terminal 230 to transmit the control information to the device 200. The server 210 includes a communication controller 211 which communicates with the remote terminal 230 through the Internet, an area number manager 212 which stores information on an area in which the device 200 is used, and a channel table storage section 214 which stores a channel table for managing channel numbers and broadcast station numbers in association with each other. The server 210 further includes a channel number transmitter 213 which extracts channel numbers corresponding to area numbers in the area number manager 212 from the channel table in the channel table storage section 214 to transmit the channel numbers to the channel number receiver 202 of the controlled device 200, a communication controller 215 which communicates with the device 200 through the Internet, and a WEB display data generator 216 which generates a screen on which an internet service is provided, such as a WEB display screen for timer recording.

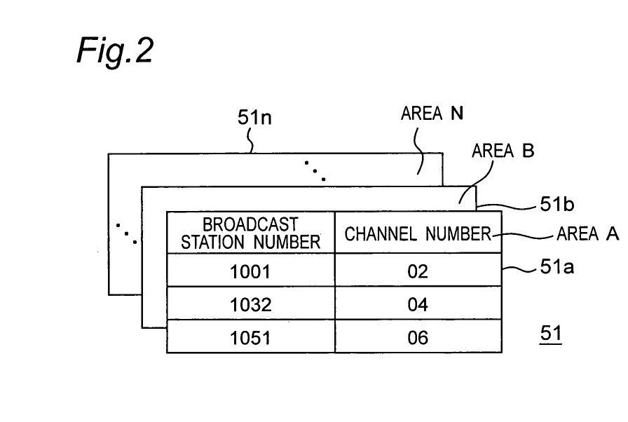

FIG. 2 shows an example of a channel table stored in the channel table storage section 214. A channel table 51 includes a plurality of tables 51a, 51b, . . . , 51n in which broadcast station numbers and channel numbers are associated with each other for each area. It is noted that the channel number is a number which is used by the device 200 to specify a broadcast station and which is allocated to each broadcast station. The broadcast station number is a number which is used by the server 210 to specify a broadcast station and which is allocated to each broadcast station.

(Timer Recording Process)

With respect to a remote control system according to the embodiment, an operation for timer recording to the device 200 located at a remote place from the remote terminal 230 through the Internet will be described below.

When a user starts an operation for timer recording on the remote terminal 230, the server 210 receives an operation start instruction from the remote terminal 230, causes the WEB display data generator 216 to generate a WEB screen, and transmits the WEB screen to the remote terminal 230. The WEB screen is displayed on the WEB display section 232 of the remote terminal 230. The user performs the operation for timer recording while watching the screen. The server 210 generates control data to the device 200 on the basis of the user operation. In particular, when the user selects a broadcast station, a broadcast station number corresponding to the broadcast station is included in data for timer recording, and the timer recording data is transmitted to the server 210 through the communication controller 231. The server 210 receives the timer recording data through the communication controller 211 and transmits the received data to the channel number transmitter 213. The timer recording data includes control information, which is necessary for timer recording, such as a start time, an end time, a recording period, and a broadcast station name of a TV program to be recorded, a record mode, and a recording medium.

The channel number transmitter 213 converts a broadcast station number included in the timer recording data into a channel number depending on an area. More specifically, one table corresponding to an area number stored in the area number manager 212 is extracted from the tables 51a, 51b, . . . , 51n of all areas of the channel table 51 stored in the channel table storage section 214. With reference to the table, the channel number corresponding to the broadcast station number is determined. The timer recording data transmitted from the remote terminal 230 includes an area number for specifying an area in which the device 200 is used (installed). The area number is stored in the area number manager 212.

The determined channel numbers are included in the timer recording data and transmitted to the device 200 through the communication controller 215. In the device 200, the channel number receiver 202 receives the timer recording data transmitted from the server 210 through the communication controller 201. The controlled device 200 selects a broadcast station depending on the channel number received in this manner and execute a timer recording process.

As described above, according to the embodiment, a table which associates broadcast station numbers with channel numbers is provided for each area and managed in the server 210. This causes the server 210 to transmit control information to the device 200 by using channel numbers recognized by the device 200. Therefore, even though different channel numbers are used in different areas, correct channel numbers can be transmitted to the device 200, and a control operation desired by a user can be executed.

### Second Embodiment

In the embodiment, an example in which a channel table associating channel information recognized by a device to be controlled with broadcast station numbers recognized by a server is stored in the device will be described.

(Configuration of Remote Control System)

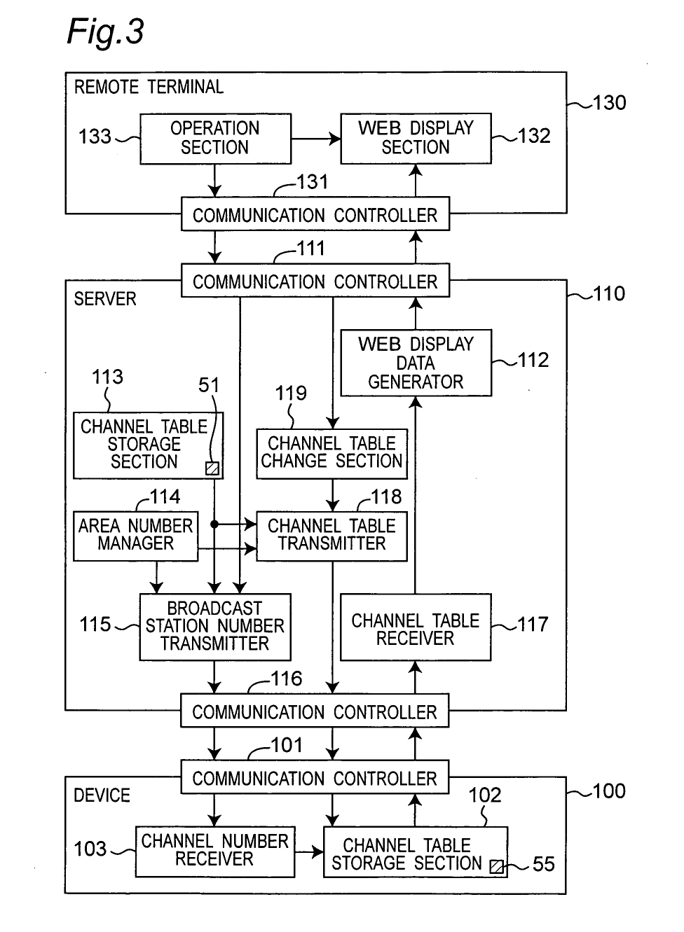

FIG. 3 is a block diagram showing the configuration of a remote control system according to the embodiment.

A remote control system according to the embodiment includes a device 100, a server 110, and a remote terminal 130. The device 100, the server 110, and the remote terminal 130 are connected to each other through a communication network such as the Internet.

The remote terminal 130 is a remote operation device which can display a WEB screen by a browser function and can perform an operation or inputting on the basis of the WEB screen, such as a PC or a mobile telephone. The remote terminal 130 includes a communication controller 131 to communicate through the Internet, a WEB display section 132 to display a WEB screen, and an operation section 133 to perform an operation or inputting on the basis of the WEB screen.

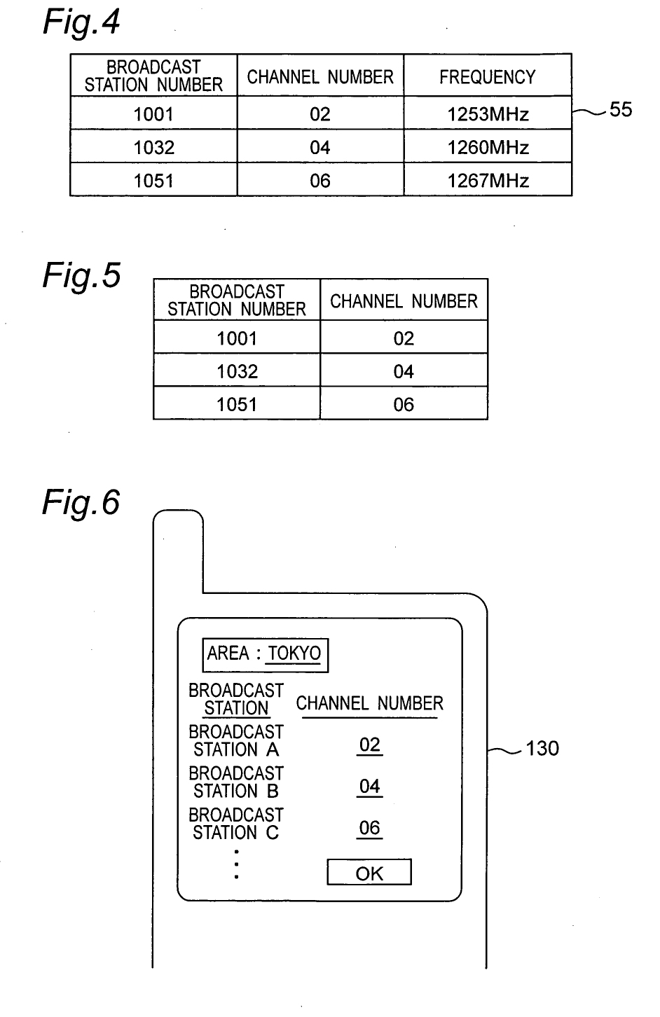

The device 100 is a controlled device which is remote-controlled through the Internet, and is a video recording apparatus which can record a program received from a broadcast station in the embodiment. The device 100 includes a communication controller 101 which performs communication through the Internet, a broadcast station number receiver 102 which receives a broadcast station number through the communication controller 101, and a channel table storage section 103 which stores a channel table. FIG. 4 is a data configuration of a channel table stored in the channel table storage section 102 of the device 100. A channel table 55 manages channel numbers, broadcast station numbers, and frequencies, associating those with each other.

The server 110 has a function of providing TV program information or the like. The server 110 includes a communication controller 111 which communicates with the Internet, an area number manager 114 which stores information about an area in which a device 100 to be controlled is used, a channel table storage section 113 which stores a channel table which associates channel numbers with broadcast station numbers and manages them, and a broadcast station number transmitter 115 which transmits a broadcast station number which is a number for specifying a broadcast station selected by a user.

The server 110 further includes a communication controller 116 to perform communication through the Internet, a channel table receiver 117 which receives data of the channel table stored in the channel table storage section 102 of the device 100, a WEB display data generator 112 which generate WEB data for displaying the data of the channel table received by the channel table receiver 117 and WEB data about a display screen for an internet service such as a WEB display screen for timer recording, a channel table change section 119 which temporarily stores a channel table changed depending on a user operation, and a channel table transmitter 118.

The channel table transmitter 118 extracts a channel number corresponding to an area number stored in the area number manager 114 from the table data stored in the channel table storage section 113 to transmit the extracted channel number to the device 100, or transmits the channel table temporarily stored in the channel table change section 119 to the device 100. An area number is included in timer recording data transmitted from the remote terminal 230, and the area number is stored in the area number manager 114.

The channel table storage section 113 stores, as default channel table data, data of the channel table 51 (see FIG. 2) which associates broadcast station numbers with channel numbers, for each area.

(Timer Recording Process)

With respect to an operation of a remote control system according to the embodiment, an operation performed when timer recording is performed to the device 100 located at a remote place, from the remote terminal 130 through the Internet will be described below.

Referring to FIG. 3, when a user starts an operation for timer recording on the remote terminal 130, the server 110 receives an operation start instruction from the remote terminal 130, causes the WEB display data generator 112 to generate a WEB screen, transmits the WEB screen to the remote terminal 130. The WEB screen is displayed on the WEB display section 132 of the remote terminal 130. The user performs the operation for timer recording while watching the screen. The server 210 generates control data to the device 200 on the basis of the user operation.

In particular, when the user selects a broadcast station for timer recording, a broadcast station number corresponding to the broadcast station is included in timer recording data, and the timer recording data is transmitted to the server 110 through the communication controller 131. When the server 110 receives the timer recording data, the broadcast station number transmitter 115 directly transmits the broadcast station number in the timer recording data to the device 100.

The device 100 receives a broadcast station number by the broadcast station number receiver 103 and transmits the received broadcast station number to the channel table storage section 102. The channel table storage section 102 specifies a channel number corresponding to the received broadcast station number with reference to the channel table 55 as shown in FIG. 4. The device 100 executes a timer recording process by using the specified channel number.

(Channel Table Setting Process in Device)

In the above description, a flow of a timer recording process has been explained. In order to execute the timer recording process, the channel table 55 corresponding to an area in which the device 100 is used or installed has to be set in advance in the channel table storage section 102 of the device 100. A setting process of the channel table 55 stored in the device 100 will be described below.

Setting process of the channel table 55 is used by a user using the remote terminal 130. The setting process is performed when, for example, the user purchases a device 100 newly and installs the device. The user sets a utilization area (installation area) where the device 100 is used on the screen as shown in FIG. 6. The information is transmitted to the area number manager 114 of the server 110. User's operation for the procedures is conducted in an operation for an operation check procedure which is performed after the device 100 is installed or an operation for subscribing internet service.

In the server 110, the channel table transmitter 118 extracts one table of an area corresponding to an area number managed by the area number manager 115 from the channel tables 51 stored in the channel table storage section 113, and transmits the extracted table to the device 100.

The device 100 updates the channel table 55 in the channel table storage section 102 on the basis of the data of the received table. More specifically, broadcast station numbers and channel numbers are transmitted from the server 110 in association with each other. The channel table storage section 102 associates the broadcast station numbers and the channel numbers in the channel table 55 with each other on the basis of a relationship between the broadcast station numbers and the channel numbers included in the received data.

Thereafter, the channel table receiver 117 of the server 110 reads data of the channel table storage section 102 and transmits the read data to the WEB display data generator 112. The WEB display data generator 112 generates WEB display data and transmits the generated WEB display data to the remote terminal 130 through the communication controller 111.

In the remote terminal 130, the WEB display section 132 displays the received data (value of the channel table) on an operation screen. The user can check whether the set channel is equal to a desired channel number in the device 100. At this time, if the broadcast station number is directly displayed, the broadcast station number is not easily understood by the user. For this reason, the broadcast station number may be converted into a broadcast station name corresponding to the broadcast station number by the server 110 to display the broadcast station name.

When the data displayed on the operation screen of the remote terminal 130 does not match the desired channel number, the user can change the data in accordance with an indication of an operation screen on the remote terminal 130. When the data is changed, the changed data is transmitted to the server 110 through the communication controller 131, and the data is temporarily stored in the channel table change section 119 in a format shown in FIG. 5. This temporary storing may be implemented by the remote terminal 130. When the user performs an operation for permitting a change, the data stored in the channel table change section 119 is transmitted to the device 100 through the channel table transmitter 118 and the communication controller 116. In the device 100, the channel table 55 is updated with the received data, and the updated table is stored in the channel table storage section 102.

In the above flow of processes, a channel table which can specify at least a broadcast station number, a channel number, and the frequency of the broadcast station is stored in the device 100 as shown in FIG. 4.

Accordingly, the channel table 55 is stored once in the device 100. In a utilization state after the storage, the server 110 and the device 100 using a broadcast station number without a channel number can exchange the timer recording data, when an operation for timer recording or the like is performed.

As described above, according to the embodiment, a user can read the channel table 55 stored in the device 100 by using the remote terminal 130 through the network to appropriately correct and change the channel table 55. Thus, even though the device 100 is installed in any area, appropriate channel setting can be achieved. A trouble state caused by mismatching between data of the server and the data of the controlled device can be avoided, and a correct timer recording operation can be executed.

The storage of the channel table in the device 100 causes nonnecessity of the channel table to be correctly managed for each area on the server 110 side. Furthermore, even though a user personally set channel numbers, the server 110 can cope with the respective channel numbers.

In the first and second embodiments, the communication controller of each device has a function of connecting the Internet. As means for connecting the Internet, various means such as a telephone line, radio transmission, an optical cable, and a cable television line can be used.

In the above description, the server in which the plurality of communication controllers are arranged has been explained. This explanation is made as a matter of convenience, one communication controller obtained by integrating such plurality of communication controllers may be used. Furthermore, the server described above can also be constituted by a plurality of servers.

The functions of the remote terminal, the server, and the device in the above embodiment can be realized by a CPU or the like executing predetermined programs in the remote terminal, the server, and the device, The present invention has been explained with respect to the specific embodiments. However, other many modifications and changes and other applications are apparent to persons skilled in the art. Therefore, the present invention is not limited to the specific disclosure and can be limited to only the accompanying claims. This application is related to Japanese Patent Application No. 2003-88421 (filed on Mar. 27, 2003), the contents of which are incorporated herein by reference.

1. A controlled device which is controlled on the basis of control information generated by a remote control device according to a user operation on a terminal at a remote place and transmitted through a network, comprising:
a storage section that stores a channel table which associates broadcast station numbers with channel numbers, the broadcast station numbers being used by the remote control device and allocated to each broadcast station, the channel numbers being used by the controlled device and allocated to each broadcast station; and
a receiver that receives control information including the broadcast station numbers through the network,
wherein the controlled device specifies the channel number on the basis of the received broadcast station number with reference to the channel table, and performs an operation based on the control information with the specified channel number.

2. The controlled device according to claim 1, wherein the channel table manages a broadcast station number, a channel number, and a frequency of a broadcast station, by associating them with each other.

3. The controlled device according to claim 1, that is a video recording apparatus capable of recording a received broadcast program.

4. The controlled device according to claim 3, wherein the control information is information necessary to perform timer recording of a broadcast program.

5. A remote control system which includes the controlled device according to claim 1 which is controlled from a terminal at a remote place through a network, and a remote control device which transmits control information to the controlled device in accordance with an instruction from the terminal, wherein
the remote control device includes:
a communication controller that receives control information including a broadcast station number through the network from the terminal; and
a transmitter that transmits the control information including the received broadcast station number to the controlled device.

6. The remote control system according to claim 5, wherein
the remote control device includes a section that reads a channel table from the controlled device to acquire a relationship between broadcast station numbers and channel numbers when a user operation related to a change in channel table on the terminal, and that changes the relationship on the basis of the user operation on the terminal to transmit the relationship to the controlled device, and
the controlled device updates the channel table on the basis of the relationship between the broadcasting station numbers and the channel numbers transmitted from the remote control device.

7. The remote control system according to claim 6, wherein
the remote control device sets an initial relationship between the broadcast station numbers and the channel numbers on the basis of area information which represents an installation area of the controlled device and is designated by a user on a terminal, and, thereafter, the relationship can be changed according to a user operation on the terminal.

8. A remote control method for a remote control system including a controlled device controlled from a terminal located at a remote place through a network and a remote control device which transmits control information to the controlled device in accordance with an instruction from the terminal, the control method comprising:
storing a channel table that associates broadcast station numbers with channel numbers in the controlled device, the broadcast station numbers being used by the remote control device and allocated to each broadcast station, the channel numbers being used by the controlled device and allocated to each broadcast station;
when a user operation related to a change in the channel table is performed on the terminal,
reading the channel table from the controlled device by the remote control device to acquire a relationship between the broadcast station number and the channel number, and changing the relationship on the basis of user operation on the terminal to transmit the relationship to the controlled device; and
updating the channel table in the controlled device on the basis of the relationship between the broadcast station number and the channel number transmitted from the remote control device.

9. The remote control method according to claim 8, wherein the channel table manages a broadcast station number, a channel number, and a frequency of a broadcast station by associating them with each other.

10. The remote control method according to claim 8, wherein the controlled device is a video recording apparatus which can record a received broadcast program.

11. The remote control method according to claim 10, wherein the control information is information necessary to perform timer recording of a broadcast program.

12. A remote control device which receives a control instruction from a terminal through a network, generates control information for a controlled device on the basis of the control instruction to transmit the control information, comprising:
a storage section that stores channel tables set for areas respectively, the channel table associating broadcast station numbers recognized by the remote control device and allocated to each broadcast station with channel numbers recognized by the controlled device and allocated to each broadcast station;
a manager that manages area information for specifying an area where the controlled device is used; and
a section that selects one table from the tables stored in the storage section on the basis of the area information managed by the manager, specifies a channel number on the basis of the selected table, and transmits the channel number as control information to the controlled device.
